(19) United States
(12) Patent Application Publication
(10) Pub. No.: US 2019/0211715 A1
(43) Pub. Date: Jul. 11, 2019

(54) HIGH EFFICIENCY SUPERCRITICAL CARBON DIOXIDE POWER GENERATION SYSTEM AND METHOD THEREFOR

(71) Applicant: INSTITUTE FOR ADVANCED ENGINEERING, Yongin (KR)

(72) Inventors: Sung Ho PARK, Yongin (KR); Joon Young KIM, Incheon (KR); Dong Ryul RHIM, Seongnam (KR); Choong Sub YEOM, Suwon (KR); Areum KO, Yongin (KR); Munkyu YOON, Yongin (KR)

(21) Appl. No.: 16/328,243

(22) PCT Filed: Jul. 17, 2017
(86) PCT No.: PCT/KR2017/007636

§ 371 Date: Feb. 25, 2019

(30) Foreign Application Priority Data
Aug. 23, 2016 (KR) 10-2016-0106964

(51) Int. Cl. F01K 25/10; F01K 7/16; F01K 13/00; B01J 19/00; B01J 19/24; C01B 3/02; C10J 3/82

(52) U.S. Cl. CPC F01K 25/103; F01K 7/16; F01K 13/006; B01J 19/0013; C10J 2300/1675; C01B 3/02; C10J 3/82; B01J 2219/00087; B01J 19/245

(57) ABSTRACT

The high efficiency supercritical carbon dioxide power generation system and the method therefor according to the present invention comprises: a hydrogen separation unit for receiving a gaseous fuel and separating the same into carbon monoxide and hydrogen; a combustion processing unit for receiving carbon monoxide and non-condensing gas discharged from the hydrogen separation unit to generate combustion gas; a carbon dioxide high purity unit for separating carbon dioxide from the combustion gas discharged from the combustion processing unit; a compression unit for pressurizing the carbon dioxide discharged from the carbon dioxide high purity unit; and a turbine unit for receiving the pressurized carbon dioxide from the compression unit to generate electricity, wherein the carbon dioxide discharged from the turbine unit may be supplied to the combustion processing unit again.

### TECHNICAL FIELD

The present invention relates to a system and method for high-efficiency supercritical carbon dioxide power generation, and, more particularly, to a system and method for high-efficiency supercritical carbon dioxide power generation in which heat of combustion gas generated by an oxyfuel combustor is supplied to an indirect heating-type supercritical carbon dioxide generation system to improve system reliability while reducing CAPEX and OPEX.

### BACKGROUND ART

Conventional fossil fuel power generation technologies are mainly divided into a steam Rankine cycle power generation technology in which heat generated through combustion of a hydrocarbon-based fuel is used to convert water into steam through an indirect heat exchange process and the steam is used to drive a turbine to produce electricity and a gas Brayton cycle power generation technology in which compressed air is burnt in a combustor along with a fuel to generate high-temperature combustion gas, which, in turn, is expanded to drive a turbine. However, the steam Rankine cycle power generation technology has a drawback in that power generation efficiency is relatively low due to phase change loss and a large system is required due to existence of a low-pressure part which is under a vacuum or low-density environment. Conversely, the gas Brayton cycle power generation system has high power generation efficiency since the temperature at an inlet of a gas turbine is very high and exhaust gas from the gas turbine has a high temperature, thereby allowing a steam Rankine cycle power generation system to be connected to a rear end of the gas turbine. However, both technologies require a separate carbon dioxide capture facilities in order to collect carbon dioxide generated through combustion of a hydrocarbon-based fuel. Carbon dioxide capture techniques applicable to both the steam Rankine cycle power generation technology and the gas Brayton cycle power generation technology may be divided into a post-combustion carbon dioxide capture technique and an oxyfuel combustion technique. The post-combustion capture technique captures carbon dioxide from exhaust gas at normal pressure after combustion and thus requires a large-scale facility and high operating costs, despite consuming less energy to capture carbon dioxide. Conversely, the oxyfuel combustion technique has an advantage in that, instead of air, high-purity oxygen is used as an oxidizing agent for oxidation of a hydrocarbon based raw material, such that combustion gas is mostly composed of carbon dioxide and steam, whereby capture of carbon dioxide can be achieved simply by condensing steam into water and discharging the water outside, thereby allowing simplification of a related system. However, the oxyfuel combustion technique has a problem of high energy consumption for preparation of high-purity oxygen.

Generally, conventional systems for supercritical carbon dioxide power generation employ a direct heating-type supercritical carbon dioxide power generation cycle, which was developed by Net Power. and is operated as follows: A hydrocarbon-based raw material is supplied to a combustor along with high-concentration oxygen to generate combustion gas having a temperature of 1000° C. or higher, wherein the operating pressure of the combustor is about 300 bar. Supercritical carbon dioxide having a pressure of 300 bar or higher is supplied to the combustor so as to control the combustion temperature of the combustor, and the combustion gas is supplied directly to a turbine to generate electricity. Combustion gas discharged from the turbine is supplied to a condensation process to condense water in the combustion gas, and high-concentration carbon dioxide is supplied back to a high-pressure oxyfuel combustor after passing through a compression process. Surplus carbon dioxide is liquefied and then captured/delivered into a pipeline. Such a conventional system for supercritical carbon dioxide power generation has a problem in that, since a combustor is operated in an oxyfuel combustion mode at a pressure of 300 bar or higher, system operation is likely to be unstable due to unstable combustion. In addition, a lot of energy and a high-capacity, high-pressure cooling system are required to condense steam generated through reaction of oxygen with hydrogen in a hydrocarbon-based raw material, causing increase in equipment and operating costs. Further, in order to liquefy surplus carbon dioxide and deliver the liquefied surplus carbon dioxide to a pipeline, a separate carbon dioxide storage utilities is required, causing increase in facility costs.

### DISCLOSURE

### Technical Problem

Embodiments of the present invention have been conceived to solve such problems in the conventional supercritical carbon dioxide power generation technologies as above mentioned and it is an aspect of the present invention to provide a high-efficiency power generation and fuel conversion process, in which heat and carbon dioxide to be supplied to a supercritical carbon dioxide power generation cycle are generated through an oxyfuel combustion process, steam and non-condensable gas are removed from combustion gas to obtain high-purity carbon dioxide after supply of heat to the supercritical carbon dioxide power generation cycle, and some of the obtained high-purity carbon dioxide is used as a working fluid of an indirect heat exchange-type supercritical carbon dioxide power generation cycle to produce electricity, while the other high-purity carbon dioxide is used to produce a fuel along with hydrogen.

### Technical Solution

In accordance with one aspect of the present invention, a system for high-efficiency supercritical carbon dioxide power generation includes: a hydrogen separator receiving a gaseous fuel and separating the gaseous fuel into carbon monoxide and hydrogen; a combustion processor generating combustion gas using carbon monoxide discharged from the hydrogen separator and non-condensable gas; a high-purity carbon dioxide capture unit separating carbon dioxide from the combustion gas discharged from the combustion processor; a compression unit pressurizing carbon dioxide discharged from the high-purity carbon dioxide capture unit; and a turbine unit generating electricity using carbon dioxide pressurized by the compression unit, wherein carbon dioxide discharged from the turbine unit is supplied back to the combustion processor.

The system for high-efficiency supercritical carbon dioxide power generation may further include: a heat exchange unit in which the combustion gas discharged from the combustion processor to be supplied to the high-purity carbon dioxide capture unit exchanges heat with carbon dioxide discharged from the compression unit to be supplied to the turbine unit; and a regenerative heat exchange unit in which carbon dioxide discharged from the turbine unit to be supplied to the combustion processor exchanges heat with carbon dioxide discharged from the compression unit to be supplied to the turbine unit, wherein the pressurized carbon dioxide discharged from the compression unit is supplied to the turbine unit after sequentially passing through the regenerative heat exchange unit and the heat exchange unit.

The system for high-efficiency supercritical carbon dioxide power generation may further include a fuel conversion unit converting a hydrocarbon-based raw material into a gaseous fuel and supplying the gaseous fuel to the hydrogen separator, wherein the gaseous fuel produced by the fuel conversion unit includes carbon monoxide and hydrogen.

The fuel conversion unit may include: a mixer mixing the hydrocarbon-based raw material with an oxidizing agent to reform the hydrocarbon-based raw material; a preheater preheating a mixture of the hydrocarbon-based raw material and the oxidizing agent discharged from the mixer; and a reforming reactor performing hydrocarbon reforming reaction with respect to the preheated mixture of the hydrocarbon-based raw material and the oxidizing agent discharged from the preheater, wherein the oxidizing agent includes any one of water vapor, oxygen, carbon dioxide, and a mixture thereof.

The combustion processor may include a combustor generating combustion gas using carbon monoxide discharged from the hydrogen separator and the non-condensable gas, wherein oxygen is supplied to the combustor through a nozzle provided to a rear end wall of the combustor to be preheated by radiant heat from a wall of the combustor and carbon dioxide discharged from the regenerative heat exchange unit is supplied in a dispersed manner to the combustor to reduce an internal temperature of the combustor.

The combustor may be operated at a pressure of 40 bar to 80 bar.

The system for high-efficiency supercritical carbon dioxide power may generation further include: a methanation unit converting hydrogen discharged from the hydrogen separator into methane through reaction with carbon dioxide, the methanation unit including a methanation reactor in which hydrogen discharged from the hydrogen separator reacts with carbon dioxide discharged from the regenerative heat exchange unit to generate methane and water, wherein methane and steam discharged from the methanation reactor is supplied to the fuel conversion unit.

The methanation unit may further include: a hydrogen preheater preheating hydrogen discharged from the hydrogen separator to be supplied to the methanation reactor; a hydrogen heat exchanger in which a mixed fluid of methane and steam discharged from the methanation reactor exchanges heat with hydrogen discharged from the hydrogen preheater; and a first knock-out drum separating methane and steam discharged from the methanation reactor.

The heat exchange unit may include a plurality of heat exchangers and the turbine unit includes a plurality of turbines such that the combustion gas discharged from the combustion processor is supplied to the high-purity carbon dioxide capture unit after passing through the plurality of heat exchangers and carbon dioxide discharged from the regenerative heat exchange unit is supplied back to the regenerative heat exchange unit after alternately passing through the plurality of heat exchangers and the plurality of turbines.

The high-purity carbon dioxide capture unit may include: a cooler cooling the combustion gas discharged from the heat exchange unit; a second knock-out drum removing condensed water from the combustion gas cooled by the cooler; and a carbon dioxide liquefaction drum separating carbon dioxide from carbon dioxide and the non-condensable gas discharged from the second knock-out drum through a liquefaction process, wherein carbon dioxide separated by the carbon dioxide liquefaction drum is supplied to the compression unit.

The compression unit may include: a first compressor pressurizing carbon dioxide discharged from the high-purity carbon dioxide capture unit; a distributor distributing carbon dioxide compressed by the first compressor to the fuel conversion unit or the regenerative heat exchange unit; and a second compressor recompressing carbon dioxide distributed by the distributor to be supplied to the regenerative heat exchange unit.

The regenerative heat exchange unit may include: a first regenerative heat exchanger in which carbon dioxide discharged from the turbine unit to be supplied to the combustion processor exchanges heat with carbon dioxide discharged from the compression unit to be supplied to the heat exchange unit; a second regenerative heat exchanger in which carbon dioxide discharged from the first regenerative heat exchanger to be supplied to the combustion processor exchanges heat with carbon dioxide discharged from the compression unit to be supplied to the first regenerative heat exchanger; and a recycling compressor receiving and compressing some of carbon dioxide discharged from the first regenerative heat exchanger to be supplied to the second regenerative heat exchanger, wherein carbon dioxide compressed by the recycling compressor joins carbon dioxide discharged from the first regenerative heat exchanger to be supplied to the heat exchange unit.

In accordance with another aspect of the present invention, a method for high-efficiency supercritical carbon dioxide power generation includes: a hydrogen separation step in which a gaseous fuel is separated into carbon monoxide and hydrogen; a combustion gas generation step in which carbon monoxide separated in the hydrogen separation step is reacted with oxygen to generate combustion gas; a carbon dioxide separation step in which carbon dioxide is separated from the combustion gas generated in the combustion gas generation step; a compression step in which carbon dioxide separated in the carbon dioxide separation step is pressurized; and an electricity generation step in which electricity is generated using carbon dioxide compressed in the compression step.

Carbon dioxide compressed in the compression step may be supplied to the electricity generation step after sequentially exchanging heat with carbon dioxide discharged after passing through the electricity generation step and the combustion gas generated in the combustion gas generation step.

The method for high-efficiency supercritical carbon dioxide power generation may further include, before the hydrogen separation step, a fuel conversion step in which a hydrocarbon-based raw material is converted into a gaseous fuel wherein the gaseous fuel generated in the fuel conversion step is supplied to the hydrogen separation step.

Hydrogen separated in the hydrogen separation step may be converted into methane through reaction with some of carbon dioxide discharged after passing through the electricity generation step, wherein methane is supplied to the fuel conversion step.

### Advantageous Effects

In the system and method for high-efficiency supercritical carbon dioxide power generation according to embodiments of the invention, since a fuel mostly composed of carbon monoxide is burnt along with oxygen in a combustor and the resultant combustion gas is used to supply heat to carbon dioxide supplied to a turbine unit instead of being directly supplied to a turbine unit, there is no problem related to use of a high-temperature material. In addition, since an oxyfuel combustor is operated at a relatively low pressure of 40 bar to 80 bar and the combustion gas discharge temperature is less than or equal to 800° C., reliability of the system can be improved, thereby reducing CAPEX and OPEX.

Further, since a gaseous fuel containing carbon monoxide and hydrogen, which is obtained through conversion of a hydrocarbon-based raw material or is separately supplied, is subjected to a hydrogen separation process before being burnt along with oxygen, the fractions of water and non-condensable gas in the combustion gas can be considerably reduced, whereby removal of the water and non-condensable gas can be achieved with very low energy consumption while enabling recovery of high-purity carbon dioxide.

Furthermore, since some of the high-purity carbon dioxide remaining after being used in an electricity generation process is converted into methane through reaction with hydrogen separated in the hydrogen separation process, use of a low-grade hydrocarbon-based raw material such as coal allows both production of electricity and acquisition of high-quality methane, thereby improving system efficiency.

### DESCRIPTION OF DRAWINGS

FIG. 1 is a schematic diagram of a system for high-efficiency supercritical carbon dioxide power generation according to one embodiment of the present invention.

FIG. 2 is a schematic diagram of a system for high-efficiency supercritical carbon dioxide power generation according to another embodiment of the present invention.

FIG. 3 is a diagram of a fuel conversion unit of a system for high-efficiency supercritical carbon dioxide power generation according to one embodiment of the present invention.

FIG. 4 is a diagram of a hydrogen separator of the system for high-efficiency supercritical carbon dioxide power generation according to one embodiment of the present invention.

FIG. 5 is a diagram of a combustion processor of a system for high-efficiency supercritical carbon dioxide power generation according to one embodiment of the present invention.

FIG. 6 is a diagram of modifications of a heat exchange unit and turbine unit according to the present invention.

FIG. 7 is a diagram of a high-purity carbon dioxide capture unit of a system for high-efficiency supercritical carbon dioxide power generation according to one embodiment of the present invention.

FIG. 8 is a diagram of a compression unit of a system for high-efficiency supercritical carbon dioxide power generation according to one embodiment of the present invention.

FIG. 9 is a diagram of a regenerative heat exchange unit of a system for high-efficiency supercritical carbon dioxide power generation according to one embodiment of the present invention.

FIG. 10 is a diagram of a methanation unit of a system for high-efficiency supercritical carbon dioxide power generation according to one embodiment of the present invention.

### BEST MODE

Hereinafter, embodiments of the present invention will be described with reference to the accompanying drawings. It should be noted that like components will be denoted by like reference numerals throughout the specification and the accompanying drawings. In addition, description of known functions and constructions which may unnecessarily obscure the subject matter of the present invention will be omitted.

Reference will now be made in detail to various embodiments, examples of which are illustrated in the accompanying drawings. It should be understood that the present invention may be embodied in different ways and is not limited to the following embodiments.

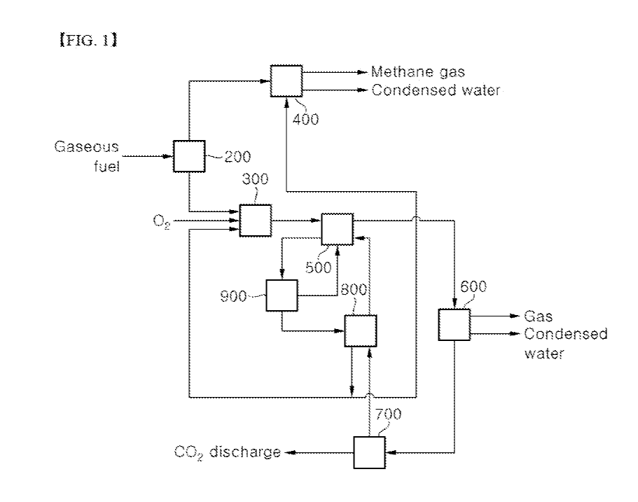

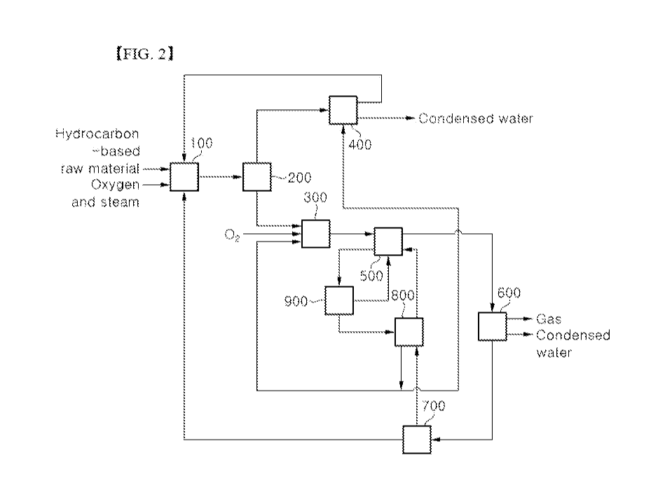

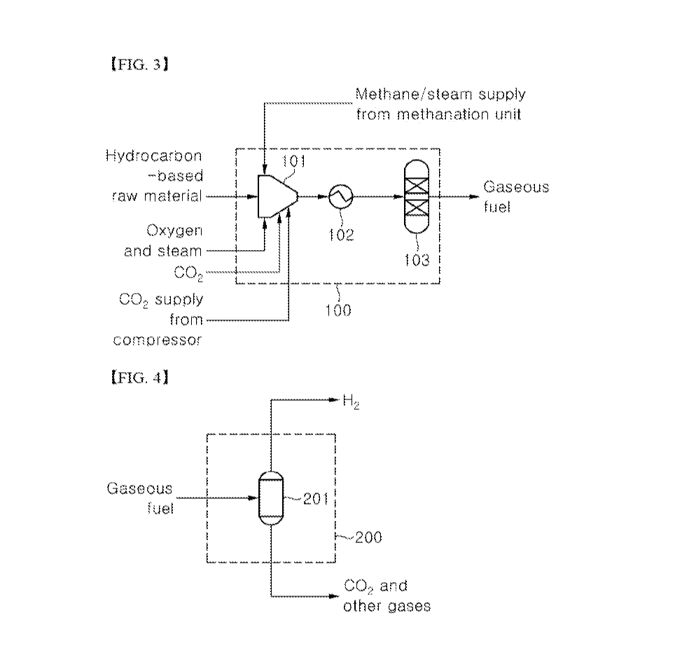

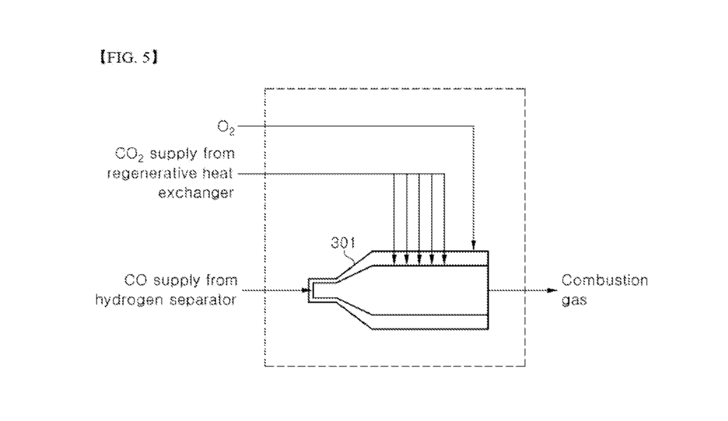

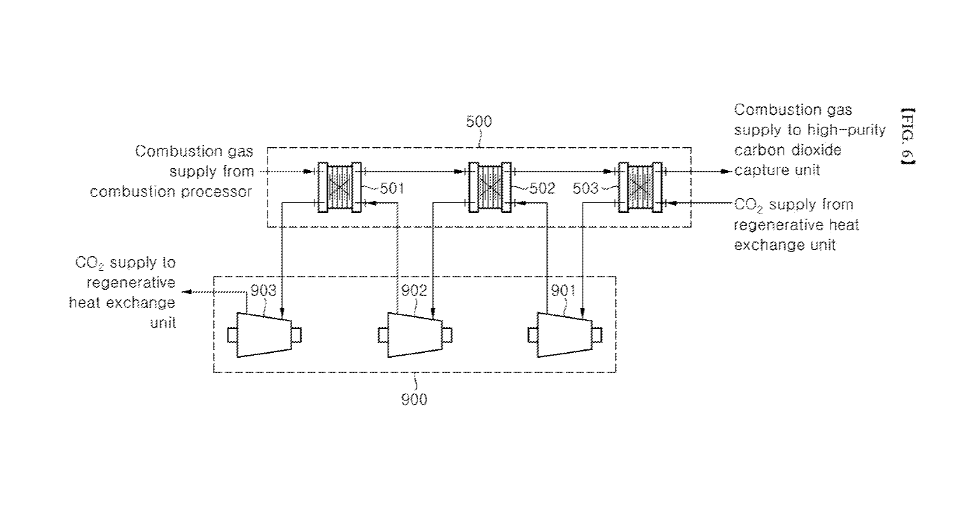

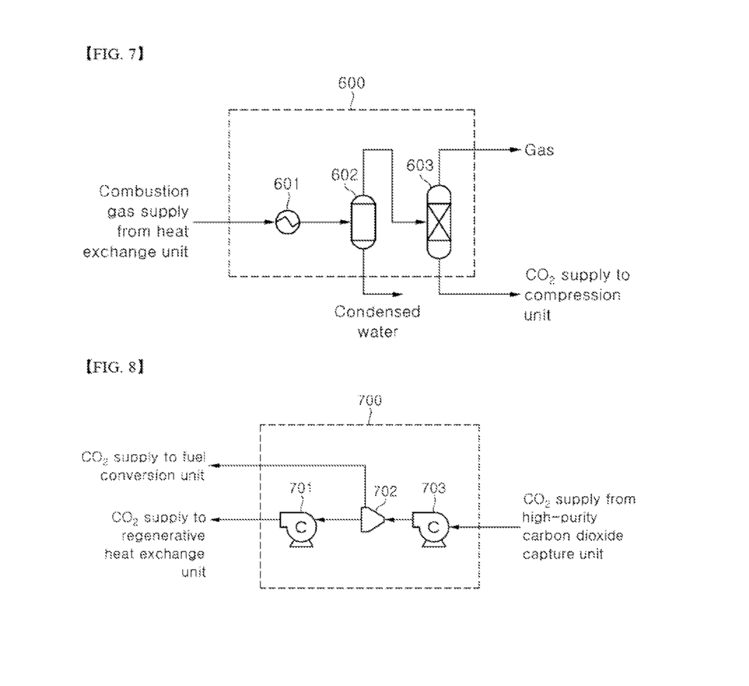

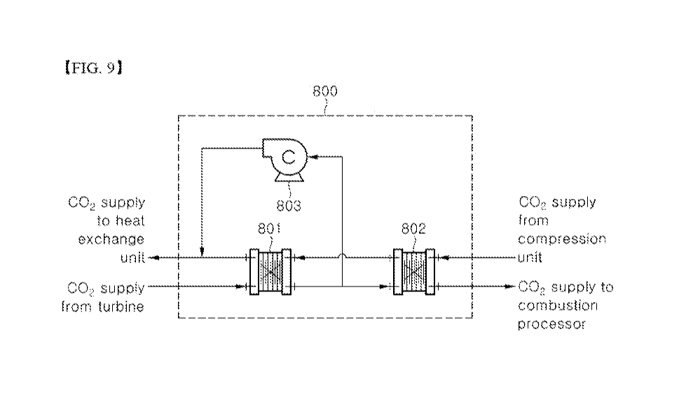

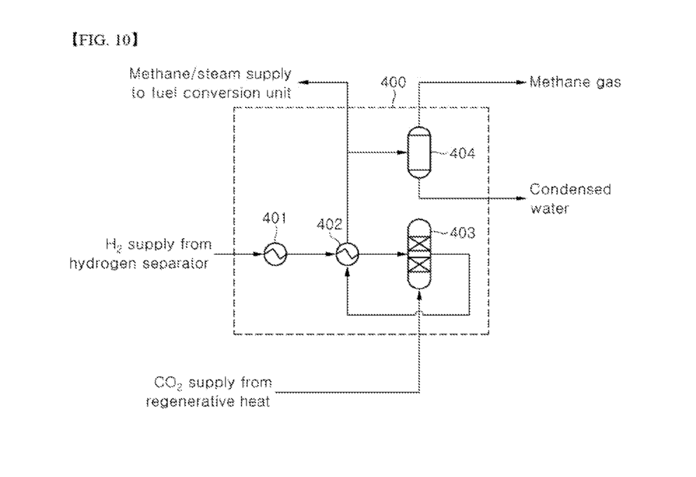

FIG. 1 is a schematic diagram of a system for high-efficiency supercritical carbon dioxide power generation according to one embodiment of the present invention, FIG. 2 is a schematic diagram of a system for high-efficiency supercritical carbon dioxide power generation according to another embodiment of the present invention, FIG. 3 is a diagram of a fuel conversion unit of a system for high-efficiency supercritical carbon dioxide power generation according to one embodiment of the present invention. FIG. 4 is a diagram of a hydrogen separator of a system for high-efficiency supercritical carbon dioxide power generation according to one embodiment of the present invention, FIG. 5 is a diagram of a combustion processor of a system for high-efficiency supercritical carbon dioxide power generation according to one embodiment of the present invention, FIG. 6 is a diagram of modifications of a heat exchange unit and turbine unit according to the present invention, FIG. 7 is a diagram of a high-purity carbon dioxide capture unit of a system for high-efficiency supercritical carbon dioxide power generation according to one embodiment of the present invention, FIG. 8 is a diagram of a compression unit of a system for high-efficiency supercritical carbon dioxide power generation according to one embodiment of the present invention. FIG. 9 is a diagram of a regenerative heat exchange unit of a system for high-efficiency supercritical carbon dioxide power generation according to one embodiment of the present invention, and FIG. 10 is a diagram of a methanation unit of a system for high-efficiency supercritical carbon dioxide power generation according to one embodiment of the present invention.

Referring to FIG. 1 and FIG. 2, a system for high-efficiency supercritical carbon dioxide power generation according to one embodiment of the present invention includes: a hydrogen separator 200 receiving a gaseous fuel and separating the gaseous fuel into carbon monoxide and hydrogen; a combustion processor 300 generating combustion gas using carbon monoxide discharged from the hydrogen separator 200 and non-condensable gas; a high-purity carbon dioxide capture unit 600 separating carbon dioxide from the combustion gas discharged from the combustion processor 300; a compression unit 700 pressurizing carbon dioxide discharged from the high-purity carbon dioxide capture unit 600; and a turbine unit 900 generating electricity using carbon dioxide pressurized by the compression unit 700, wherein carbon dioxide discharged from the turbine unit 900 may be supplied back to the combustion processor 300.

That is, conversion of chemical energy into thermal energy can be performed by supplying carbon monoxide separated by the hydrogen separator 200 to the combustion processor 300 along with high-purity oxygen, while the fractions of steam and non-condensable gas in combustion gas discharged from the combustion processor 300 can be reduced and the fraction of carbon dioxide in the combustion gas can be increased by separating hydrogen from the gaseous fuel using the hydrogen separator 200.

Referring to FIG. 5, the combustion processor 300 includes a combustor 301 receiving carbon monoxide discharged from the hydrogen separator 200 and non-condensable gas and generating combustion gas, wherein oxygen may be supplied to the combustor 301 through a nozzle provided to a rear end wall of the combustor 301 to be preheated by radiant heat from a wall of the combustor 301 and carbon dioxide from a regenerative heat exchange unit 800 described below may be supplied in a dispersed manner to the combustor 301 to serve as a diluent for controlling the internal temperature of the combustor 301 and reducing the temperature at a rear end of the combustor to less than 800° C.

The combustor 301 is operated at a pressure of 40 bar to 80 bar and discharges combustion gas having a temperature of 800° C. or less. The combustion gas may supply heat to carbon dioxide to be supplied to the turbine unit 900 through a heat exchange process, and carbon dioxide receiving heat from the combustion gas may be supplied to the turbine unit 900 to generate electricity.

In a conventional directly heated supercritical carbon dioxide power generation cycle, a hydrocarbon-based raw material is directly supplied to a combustor along with high-concentration oxygen to generate combustion gas having a temperature of 1000° C. or higher, wherein the combustor is operated at a pressure of about 300 bar and supercritical carbon dioxide having a pressure of 300 bar or higher is supplied to the combustor to control the combustion temperature of the combustor, such that the generated combustion gas is directly supplied to a turbine to generate electricity.

However, since the combustor needs to be operated in an oxyfuel combustion mode at a pressure of 300 bar or higher, system operation is likely to be unstable due to unstable combustion. In addition, a lot of energy and a high-capacity, high-pressure cooling facility are required to condense steam generated through reaction of oxygen with hydrogen in the hydrocarbon-based raw material, causing increase in facility and operating costs, and a separate carbon dioxide storage facility is required to liquefy surplus carbon dioxide and deliver the liquefied carbon dioxide to a pipeline.

In order to address such problems, the present invention provides an indirectly heated supercritical carbon dioxide power generation system which uses combustion gas generated by the oxyfuel combustor 301 operated at a pressure of 40 bar to 80 bar as a heat source, wherein a fuel rich in carbon monoxide is supplied to the oxyfuel combustor 301 to increase the concentration of carbon dioxide in the combustion gas and to reduce the contents of steam and non-condensable gas in the combustion gas, thereby increasing the purity of a working fluid of a carbon dioxide cycle while simplifying a process of removing gaseous impurities (steam, non-condensable gas, etc.).

Referring to FIG. 3, the system according to the present invention may further include a fuel conversion unit 100 converting a hydrocarbon-based raw material into a gaseous fuel and supplying the gaseous fuel to the hydrogen separator. The fuel conversion unit 100 may include a mixer 101 mixing the hydrocarbon-based raw material with an oxidizing agent to reform the hydrocarbon-based raw material, a preheater 102 preheating a mixture of the hydrocarbon-based raw material and the oxidizing agent discharged from the mixer 101, and a reforming reactor 103 performing a hydrocarbon reforming reaction of the mixture of the hydrocarbon-based raw material and the oxidizing agent preheated by the preheater 102, wherein the oxidizing agent may be any one of steam, oxygen, carbon dioxide, and mixtures thereof, depending on reforming methods. In addition, the preheater 102 may be optionally provided depending on the operation temperature of the reforming reactor.

The gaseous fuel generated by the fuel conversion unit 100 may be supplied to the hydrogen separator 200 to be separated into hydrogen and carbon monoxide, which, in turn, is supplied to the combustion processor 300 to generate combustion gas, which may transfer heat to carbon dioxide separated by the high-purity carbon dioxide capture unit 600 and having been pressurized by the compression unit 700 through a heat exchange process.

The system according to the present invention may further include a heat exchange unit 500 in which combustion gas discharged from the combustion processor 300 to be supplied to the high-purity carbon dioxide capture unit 600 exchanges heat with carbon dioxide discharged from the compression unit 700 to be supplied to the turbine unit 900. That is, with the heat exchange unit, the combustion gas discharged from the combustion processor 300 can transfer heat to carbon dioxide pressurized by the compression unit 700.

The system according to the present invention may further include a regenerative heat exchange unit 800 in which carbon dioxide discharged from the turbine unit 900 to be supplied to the combustion processor 300 exchanges heat with carbon dioxide discharged from the compression unit 700 to be supplied to the turbine unit 900 or the heat exchange unit 500. That is, with the regenerative heat exchange unit, carbon dioxide discharged from the turbine unit 900 can supply heat to carbon dioxide discharged from the compression unit 700.

Referring to FIG. 9, the regenerative heat exchange unit 800 may include a first regenerative heat exchanger 801 in which carbon dioxide discharged from the turbine unit to be supplied to the combustion processor 300 exchanges heat with carbon dioxide discharged from the compression unit 700 to be supplied to the heat exchange unit 500, a second regenerative heat exchanger 802 in which carbon dioxide discharged from the first regenerative heat exchanger 801 to be supplied to the combustion processor 300 exchanges heat with carbon dioxide discharged from the compression unit 700 to be supplied to the first regenerative heat exchanger 801, and a recycling compressor 803 receiving and compressing some of carbon dioxide discharged from the first regenerative heat exchanger 801 to be supplied to the second regenerative heat exchanger 802, wherein carbon dioxide compressed by the recycling compressor 803 may join carbon dioxide discharged from the first regenerative heat exchanger 801 to be supplied to the heat exchange unit 500.

That is, in the regenerative heat exchange unit 800, carbon dioxide discharged from the turbine unit 900 exchanges heat with carbon dioxide discharged from the compression unit 700, and some of carbon dioxide discharged from the first regenerative heat exchanger 801 to be supplied to the second regenerative heat exchanger 802 is supplied to and compressed by the recycling compressor 803 and then joins carbon dioxide discharged from the first regenerative heat exchanger 801 to be supplied to the heat exchange unit 500 so as to improve thermal efficiency.

In this way, pressurized carbon dioxide from the compression unit 700 can be supplied to the turbine unit 900 after receiving heat while sequentially passing through the regenerative heat exchange unit 800 and the heat exchange unit 500.

For example, the heat exchange unit 500 may include a plurality of heat exchangers and the turbine unit 900 may include a plurality of turbines. Combustion gas discharged from the combustion processor 300 may be supplied to the high-purity carbon dioxide capture unit 600 after passing through the plurality of heat exchangers of the heat exchange unit 500, and carbon dioxide discharged from the regenerative heat exchange unit 800 may be supplied back to the regenerative heat exchange unit 800 after alternately passing through the plurality of heat exchangers of the heat exchange unit 500 and the plurality of turbines of the turbine unit 900.

Referring to FIG. 6, which shows a modified example of the heat exchange unit and the turbine unit according to the present invention, the heat exchange unit 500 may be configured as a multistage heat exchanger depending on the total power generation capacity and the calorific value of combustion gas supplied thereto. In this case, carbon dioxide supplied to the turbine unit 900 may undergo heat exchange in a counter flow manner, and carbon dioxide discharged from the turbine unit 900 may be supplied back to the turbine unit 900 after undergoing heat exchange.

That is, the heat exchange unit 500 may include a first heat exchanger 501, a second heat exchanger 502, and a third heat exchanger 503, such that combustion gas discharged from the combustion processor 300 may be supplied to the high-purity carbon dioxide capture unit 600 after passing through the first heat exchanger 501, the second heat exchanger 502, and the third heat exchanger 503.

The turbine unit 900 may include a first turbine 901, a second turbine 902, and a third turbine 903, such that carbon dioxide discharged from the regenerative heat exchange unit 800 is supplied to the first turbine 901 after exchanging heat with combustion gas discharged from the second heat exchanger 502 to be supplied to the high-purity carbon dioxide capture unit 600 in the third heat exchanger 503 and carbon dioxide expanded by the first turbine 901 is supplied to the second turbine 902 after exchanging heat with combustion gas discharged from the first heat exchanger 501 to be supplied to the third heat exchanger 503 in the second heat exchanger 502.

In addition, carbon dioxide expanded by the second turbine 902 may be supplied to the third turbine 903 after exchanging heat with combustion gas discharged from the combustion processor 300 to be supplied to the second heat exchanger 502 in the first heat exchanger 501, and carbon dioxide expanded by the third turbine 903 may be supplied to the regenerative heat exchange unit 800.

In order to use combustion gas in the carbon dioxide power generation cycle and a methanation process, it is necessary to remove steam and non-condensable gas from the combustion gas. Accordingly, combustion gas discharged from the combustion processor 300 and having transferred heat to carbon dioxide in the heat exchange unit 500 may be supplied to the high-purity carbon dioxide capture unit 600 to remove steam and non-condensable gas from the combustion gas to obtain high-purity carbon dioxide.

Referring to FIG. 7, the high-purity carbon dioxide capture unit 600 may include a cooler 601 cooling combustion gas discharged from the heat exchange unit 500, a second knock-out drum 602 removing condensed water from the combustion gas cooled by the cooler 601, and a carbon dioxide liquefaction drum 603 separating carbon dioxide from carbon dioxide and non-condensable gas discharged from the second knock-out drum 602 through a liquefaction process.

That is, the combustion gas is supplied to the second knock-out drum 602 after being cooled to or below a temperature at which water is condensed by a cooling fluid in the cooler 601, wherein condensed water is discharged through a lower side of the knock-out drum 602 and carbon dioxide and non-condensable gas are discharged through an upper side of the second knock-out drum 602. The carbon dioxide and non-condensable gas discharged from the upper side of the second knock-out drum are supplied to the carbon dioxide liquefaction drum 603, which allows the carbon dioxide to be liquefied by the cooling fluid and to be discharged through a lower side thereof while allowing the non-condensable gas to be discharged through an upper side thereof.

High-purity carbon dioxide separated by the high-purity carbon dioxide capture unit 600 may be supplied to the compression unit 700 to be pressurized to 150 bar or higher. Referring to FIG. 8, the compression unit 700 may include a first compressor 703 pressurizing carbon dioxide discharged from the high-purity carbon dioxide capture unit 600, a distributor 702 distributing carbon dioxide compressed by the first compressor 703 to the fuel conversion unit 100 or the regenerative heat exchange unit 800, and a second compressor 701 recompressing carbon dioxide distributed by the distributor 702 to be supplied to the regenerative heat exchange unit 800.

Some of carbon dioxide pressurized by the first compressor 703 is supplied to the second compressor 701 by the distributor 702 to be used as a working fluid of the carbon dioxide power generation cycle, and the other carbon dioxide is discharged outside or is used as carbon dioxide required by the fuel conversion unit 100. Carbon dioxide pressurized by the second compressor 701 may be supplied to the regenerative heat exchange unit 800 to recover heat from carbon dioxide discharged from the turbine unit 900.

The carbon dioxide having passed through the turbine unit 900 and the regenerative heat exchange unit 800 may be supplied at a relatively low pressure/temperature to the combustion processor 300 or a methanation unit 400.

Referring to FIG. 10, the methanation unit 400 converts hydrogen discharged from the hydrogen separator 200 into methane through reaction with carbon dioxide, and includes a methanation reactor 403 in which hydrogen discharged from the hydrogen separator 200 reacts with carbon dioxide discharged from the regenerative heat exchange unit 800 to generate methane and water, wherein methane and steam discharged from the methanation reactor 403 may be supplied to the fuel conversion unit 100.

The methanation unit 400 may further include a hydrogen preheater 401 preheating hydrogen discharged from the hydrogen separator 200 to be supplied to the methanation reactor 403, a hydrogen heat exchanger 402 allowing a mixed fluid of methane and steam discharged from the methanation reactor 403 to exchange heat with hydrogen discharged from the hydrogen preheater 401, and a first knock-out drum 404 separating methane and steam discharged from the methanation reactor 403.

That is, hydrogen separated by the hydrogen separator 200 and having been supplied to the methanation unit 400 recovers heat from methane discharged from the methanation reactor 403 and then is supplied to the methanation reactor 403. The hydrogen preheater 401 may be optionally provided depending on the temperature of hydrogen supplied to the methanation reactor 403. Hydrogen and carbon dioxide supplied to the methanation reactor 403 are converted into methane and water in the methanation reactor 403 according to the following reaction equation:

CO_{2(g)}+4H_{2(g)}↔CH₄+2H₂O₍ₗ₎

Whether to separate methane and water discharged from the methanation reactor 403 depends on the use of methane. When methane is to be recirculated to the fuel conversion unit 100, methane may be supplied to the fuel conversion unit 100 along with water without passing through the first knock-out drum 404 since water is used as an oxidizing agent in the fuel conversion unit 100. On the other hand, when methane is to be stored separately or used in another process, water is removed by the first knock-out drum 404 to obtain high-purity methane.

In accordance with another aspect of the present invention, a method for high-efficiency supercritical carbon dioxide power generation includes: a hydrogen separation step in which a gaseous fuel is separated into carbon monoxide and hydrogen; a combustion gas generation step in which carbon monoxide separated in the hydrogen separation step is reacted with oxygen to generate combustion gas; a carbon dioxide separation step in which high-purity carbon dioxide is separated from the combustion gas generated in the combustion gas generation step; a compression step in which carbon dioxide separated in the carbon dioxide separation step is pressurized; and an electricity generation step in which electricity is generated using carbon dioxide compressed in the compression step.

The method for high-efficiency supercritical carbon dioxide power generation may further include, before the hydrogen separation step, a fuel conversion step in which a hydrocarbon-based raw material is converted into a gaseous fuel, wherein the gaseous fuel generated in the fuel conversion step may be supplied to the hydrogen separation step.

In addition, hydrogen separated in the hydrogen separation step may be converted into methane through reaction with some of carbon dioxide discharged after passing through the electricity generation step, wherein methane may be used in the fuel conversion step.

In addition, carbon dioxide pressurized in the compression step may be used in the electricity generation step after sequentially exchanging heat with carbon dioxide discharged after passing through the electricity generation step and the combustion gas generated in the combustion gas generation step.

As described above, in the system and method for high-efficiency supercritical carbon dioxide power generation according to the embodiments of the invention, since a fuel mostly composed of carbon monoxide is burnt along with oxygen in the combustor and the resultant combustion gas is used to supply heat to carbon dioxide supplied to the turbine unit instead of being directly supplied to the turbine unit, there is no problem related to use of a high-temperature material. In addition, since the oxyfuel combustor is operated at a relatively low pressure of 40 bar to 80 bar and the combustion gas discharge temperature is less than or equal to 800° C. reliability of the system can be improved, thereby reducing facility and operating costs.

Further, since a gaseous fuel containing carbon monoxide and hydrogen, which is obtained through conversion of a hydrocarbon-based raw material or is separately supplied, is subjected to a hydrogen separation process before being burnt along with oxygen, the fractions of water and non-condensable gas in the combustion gas can be considerably reduced, whereby removal of the water and non-condensable gas can be achieved with very low energy consumption, while high-purity carbon dioxide can be recovered.

Furthermore, since some of the high-purity carbon dioxide remaining after being used in an electricity generation process is converted into methane through reaction with hydrogen separated in the hydrogen separation process, use of a low-grade hydrocarbon-based raw material such as coal allows both production of electricity and acquisition of high-quality methane, thereby improving system efficiency.

While some embodiments have been described herein, it should be understood that these embodiments have been provided by way of example only and are not intended to limit the scope of the present invention. Indeed, the embodiments described herein may be embodied in a variety of other forms. Furthermore, it should be understood that various omissions, substitutions and changes in the form of the embodiments described herein may be made without departing from the spirit of the present invention. The accompanying claims and their equivalents are intended to cover such forms or modifications as would fall within the scope and spirit of the present invention.

Accordingly, it will be understood by those of skill in the art that various changes in form and details may be made without departing from the spirit and scope of the present invention as set forth in the following claims.

1. A system for high-efficiency supercritical carbon dioxide power generation comprising:
a hydrogen separator receiving a gaseous fuel and separating the gaseous fuel into carbon monoxide and hydrogen;
a combustion processor generating combustion gas using carbon monoxide discharged from the hydrogen separator and non-condensable gas;
a high-purity carbon dioxide capture unit separating carbon dioxide from the combustion gas discharged from the combustion processor;
a compression unit pressurizing carbon dioxide discharged from the high-purity carbon dioxide capture unit; and
a turbine unit generating electricity using carbon dioxide pressurized by the compression unit,
wherein carbon dioxide discharged from the turbine unit is supplied back to the combustion processor.

2. The system for high-efficiency supercritical carbon dioxide power generation according to claim 1, further comprising:
a heat exchange unit in which the combustion gas discharged from the combustion processor to be supplied to the high-purity carbon dioxide capture unit exchanges heat with carbon dioxide discharged from the compression unit to be supplied to the turbine unit; and
a regenerative heat exchange unit in which carbon dioxide discharged from the turbine unit to be supplied to the combustion processor exchanges heat with carbon dioxide discharged from the compression unit to be supplied to the turbine unit,
wherein the pressurized carbon dioxide discharged from the compression unit is supplied to the turbine unit after sequentially passing through the regenerative heat exchange unit and the heat exchange unit.

3. The system for high-efficiency supercritical carbon dioxide power generation according to claim 2, further comprising:
a fuel conversion unit converting a hydrocarbon-based raw material into a gaseous fuel and supplying the gaseous fuel to the hydrogen separator,
wherein the gaseous fuel produced by the fuel conversion unit comprises carbon monoxide and hydrogen.

4. The system for high-efficiency supercritical carbon dioxide power generation according to claim 3, wherein the fuel conversion unit comprises:
a mixer mixing the hydrocarbon-based raw material with an oxidizing agent to reform the hydrocarbon-based raw material;
a preheater preheating a mixture of the hydrocarbon-based raw material and the oxidizing agent discharged from the mixer; and
a reforming reactor performing a hydrocarbon reforming reaction with respect to the preheated mixture of the hydrocarbon-based raw material and the oxidizing agent discharged from the preheater,
wherein the oxidizing agent comprises any one of water vapor, oxygen, carbon dioxide, and a mixture thereof.

5. The system for high-efficiency supercritical carbon dioxide power generation according to claim 2, wherein the combustion processor comprises a combustor generating combustion gas using carbon monoxide discharged from the hydrogen separator and the non-condensable gas, oxygen is supplied to the combustor through a nozzle provided to a rear end wall of the combustor to be preheated by radiant heat from a wall of the combustor, and carbon dioxide discharged from the regenerative heat exchange unit is supplied in a dispersed manner to the combustor to reduce an internal temperature of the combustor.

6. The system for high-efficiency supercritical carbon dioxide power generation according to claim 5, wherein the combustor is operated at a pressure of 40 bar to 80 bar.

7. The system for high-efficiency supercritical carbon dioxide power generation according to claim 3, further comprising:
a methanation unit converting hydrogen discharged from the hydrogen separator into methane through reaction with carbon dioxide,
the methanation unit comprising a methanation reactor in which hydrogen discharged from the hydrogen separator reacts with carbon dioxide discharged from the regenerative heat exchange unit to generate methane and water,
wherein methane and steam discharged from the methanation reactor is supplied to the fuel conversion unit.

8. The system for high-efficiency supercritical carbon dioxide power generation according to claim 7, wherein the methanation unit further comprises:
a hydrogen preheater preheating hydrogen discharged from the hydrogen separator to be supplied to the methanation reactor;
a hydrogen heat exchanger in which a mixed fluid of methane and steam discharged from the methanation reactor exchanges heat with hydrogen discharged from the hydrogen preheater; and
a first knock-out drum separating methane and steam discharged from the methanation reactor.

9. The system for high-efficiency supercritical carbon dioxide power generation according to claim 2, wherein the heat exchange unit comprises a plurality of heat exchangers and the turbine unit comprises a plurality of turbines such that the combustion gas discharged from the combustion processor is supplied to the high-purity carbon dioxide capture unit after passing through the plurality of heat exchangers and carbon dioxide discharged from the regenerative heat exchange unit is supplied back to the regenerative heat exchange unit after alternately passing through the plurality of heat exchangers and the plurality of turbines.

10. The system for high-efficiency supercritical carbon dioxide power generation according to claim 2, wherein the high-purity carbon dioxide capture unit comprises:
a cooler cooling the combustion gas discharged from the heat exchange unit;
a second knock-out drum removing condensed water from the combustion gas cooled by the cooler; and
a carbon dioxide liquefaction drum separating carbon dioxide from carbon dioxide and the non-condensable gas discharged from the second knock-out drum through a liquefaction process,
wherein carbon dioxide separated by the carbon dioxide liquefaction drum is supplied to the compression unit.

11. The system for high-efficiency supercritical carbon dioxide power generation according to claim 3, wherein the compression unit comprises:
a first compressor pressurizing carbon dioxide discharged from the high-purity carbon dioxide capture unit;
a distributor distributing carbon dioxide compressed by the first compressor to the fuel conversion unit or the regenerative heat exchange unit; and
a second compressor recompressing carbon dioxide distributed by the distributor to be supplied to the regenerative heat exchange unit.

12. The system for high-efficiency supercritical carbon dioxide power generation according to claim 2, wherein the regenerative heat exchange unit comprises:
a first regenerative heat exchanger in which carbon dioxide discharged from the turbine unit to be supplied to the combustion processor exchanges heat with carbon dioxide discharged from the compression unit to be supplied to the heat exchange unit;
a second regenerative heat exchanger in which carbon dioxide discharged from the first regenerative heat exchanger to be supplied to the combustion processor exchanges heat with carbon dioxide discharged from the compression unit to be supplied to the first regenerative heat exchanger; and
a recycling compressor receiving and compressing some of carbon dioxide discharged from the first regenerative heat exchanger to be supplied to the second regenerative heat exchanger,
wherein carbon dioxide compressed by the recycling compressor joins carbon dioxide discharged from the first regenerative heat exchanger to be supplied to the heat exchange unit.

13. A high-efficiency supercritical carbon dioxide power generation method comprising:
a hydrogen separation step in which a gaseous fuel is separated into carbon monoxide and hydrogen;
a combustion gas generation step in which carbon monoxide separated in the hydrogen separation step is reacted with oxygen to generate combustion gas;
a carbon dioxide separation step in which carbon dioxide is separated from the combustion gas generated in the combustion gas generation step;
a compression step in which carbon dioxide separated in the carbon dioxide separation step is pressurized; and
an electricity generation step in which electricity is generated using carbon dioxide compressed in the compression step.

14. The method for high-efficiency supercritical carbon dioxide power generation according to claim 13, wherein carbon dioxide compressed in the compression step is supplied to the electricity generation step after sequentially exchanging heat with carbon dioxide discharged after passing through the electricity generation step and the combustion gas generated in the combustion gas generation step.

15. The method for high-efficiency supercritical carbon dioxide power generation according to claim 13, further comprising, before the hydrogen separation step,
a fuel conversion step in which a hydrocarbon-based raw material is converted into a gaseous fuel,
wherein the gaseous fuel generated in the fuel conversion step is supplied to the hydrogen separation step.

16. The method for high-efficiency supercritical carbon dioxide power generation according to claim 15, wherein hydrogen separated in the hydrogen separation step is converted into methane through reaction with some of carbon dioxide discharged after passing through the electricity generation step, methane being supplied to the fuel conversion step.
